(19) United States
(12) Patent Application Publication
(10) Pub. No.: US 2003/0030007 A1
(43) Pub. Date: Feb. 13, 2003

(54) Charged particle beam control apparatus

(76) Inventors: Tsutomu Karimata, Kanagawa (JP); Weiming Ren, Kanagawa (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/191,795

(22) Filed: Jul. 10, 2002

(30) Foreign Application Priority Data
Jul. 11, 2001 (JP) 210862/2001

(51) Int. Cl. G21K 1/08

(52) U.S. Cl. 250/396 R

(57) ABSTRACT

A charged particle beam control apparatus capable of being inserted into a narrow space between lenses to correct the path of a charged particle beam and to correct aberrations is provided, together with a charged particle beam optical apparatus, a charged particle beam defect inspection apparatus and a charged particle beam control method, which use the charged particle beam control apparatus. One and other electrodes are provided around the path of a charged particle beam to form beam controllers, respectively. The electrodes are formed by coating Au (gold) on the inner peripheral surface of a cylindrical insulator. The beam controllers are provided on the insulator along the path of the charged particle beam to constitute a charged particle beam control apparatus.

### BACKGROUND OF THE INVENTION

The present invention relates to a charged particle beam control apparatus having a beam controller for generating an electric field in the path of a charged particle beam to control the beam. More particularly, the present invention relates to a charged particle beam control apparatus suitable for use to correct the path of a charged particle beam by deflecting the beam when entering a lens for focusing it. The present invention also relates to a charged particle beam optical apparatus, a charged particle beam defect inspection apparatus and a charged particle beam control method, which use the charged particle beam control apparatus.

There is a charged particle beam optical apparatus in which charged particles, e.g. electrons, are led as a charged particle beam through a plurality of lenses and imaged on a detection surface. Ideally, the lenses for the charged particle beam optical apparatus need to be arranged so that the optical axes of all the lenses coincide with each other. In actuality, however, the lenses are decentered owing to mechanical errors occurring during assembly, so that the optical axes of the lenses are displaced from each other. The displacement of the optical axes of the lenses causes aberrations. Consequently, the path of the focused charged particle beam may be displaced or tilted. This eventually causes the quality of the formed image to be degraded.

To reduce the image quality degradation due to the displacement of the lens position, it is necessary not only to improve the accuracy of the lens position as much as possible but also to dispose a charged particle beam control apparatus for controlling a charged particle beam at the upstream side of each lens as viewed in the direction of travel of the charged particle beam in order to correct the position and tilt of the charged particle beam so that the optical axis of the lens and the path of the charged particle beam coincide with each other, and eventually to correct the position where the image is formed.

The term “the position and tilt of the charged particle beam” as used herein means the relative positional relationship between the path of an ideal charged particle beam coincident with the optical axis of the lens and the path of the actual charged particle beam. That is, the position of the charged particle beam is the position at which the charged particle beam intersects a plane perpendicular to the optical axis of the lens (or the path of the ideal charged particle beam), and the tilt of the charged particle beam is the tilt in the tangential direction of the charged particle beam at the position of intersection between the charged particle beam and the plane perpendicular to the optical axis. It should be noted that the position at which the charged particle beam intersects a plane perpendicular to the optical axis and the tilt of the charged particle beam at that position shall be determined by the gravitational center of the beam emittance in the phase space.

As shown in FIG. 11, at least two charged particle beam control apparatus are needed to correct two parameters, i.e. the position and tilt of a charged particle beam, in regard to a certain direction. That is, charged particle beam deflectors D1 and D2 for deflecting the charged particle beam are used as charged particle beam control apparatus. First, the charged particle beam is deflected by the first charged particle beam deflector D1 so that the path of the charged particle beam and the optical axis of a lens L intersect each other at the position of the second charged particle beam deflector D2. Then, the tilt of the charged particle beam is corrected by the second charged particle beam deflector D2 so that the path of the charged particle beam and the optical axis of the lens L coincide with each other.

Actually, the position and tilt of the charged particle beam intersecting a plane perpendicular to the optical axis of a lens are described by two independent axis directions, e.g. an X axis and a Y axis. Therefore, the position and tilt of the charged particle beam are corrected for each of the two directions to make the optical axis of the lens and the path of the charged particle beam coincide with each other, as stated above. Thus, the occurrence of aberrations due to the displacement between the path of the charged particle beam and the optical axis of the lens is minimized, and thus the quality of the image formed can be improved.

However, a charged particle beam optical apparatus according to the related art such as that arranged to use electrons of low energy (of the order of several keV) as a charged particle beam, for example, has an overall length minimized in order to suppress the increase of the beam emittance due to the spatial electric charge action. Accordingly, there is no sufficient space to insert two charged particle beam control apparatus at the upstream side of a lens. Consequently, as shown in FIG. 12 by way of example, only one first charged particle beam deflector D1 can be inserted at the upstream side (left-hand side in FIG. 12) of a lens L. Accordingly, even if the position of the charged particle beam can be corrected so that the charged particle beam enters the lens L at a position where it intersects the optical axis of the lens L, the tilt of the path of the charged particle beam with respect to the optical axis still remains uncorrected. Consequently, aberrations due to the lens L cannot be reduced.

In general, it is necessary in order to reduce aberrations due to a lens not only to control the path of the charged particle beam but also to insert a charged particle beam control apparatus such as a stigmator for correcting astigmatism or a lens for aberration correction. The related art suffers from the problem that there is no sufficient space to insert such a charged particle beam control apparatus between lenses.

The present invention was made in view of the above-described circumstances. Accordingly, an object of the present invention is to provide a charged particle beam control apparatus capable of being inserted into a narrow space between lenses for focusing a charged particle beam to correct the path of the charged particle beam and to correct aberrations, and also provide a charged particle beam optical apparatus, a charged particle beam defect inspection apparatus and a charged particle beam control method, which use the charged particle beam control apparatus.

### SUMMARY OF THE INVENTION

In the following examples shown in this section, the present invention will be described by using typical reference numerals denoting the specific features of the present invention, which are shown in the drawings illustrating embodiments thereof. It should be noted, however, that neither the structure of the present invention nor each specific feature of the invention is not limited to those restricted by the reference numerals.

A charged particle beam control apparatus (A) according to the present invention has a beam controller (11, 12) for generating an electric field in the path of a charged particle beam. The beam controller (11, 12) has a plurality of electrodes (11a-11d, 12a-12d) arranged around the path so that a voltage is applied to each electrode. The electrodes (11a-11d, 12a-12d) are each formed from an electrically conductive substance coated on a part of the surface of an insulator (13) extending along the path. A plurality of beam controllers (11, 12) may be provided on the insulator (13) along the path.

In the beam controller, when a voltage is applied to each of the plurality of electrodes arranged around the path of the charged particle beam, an electric field is generated in the path of the charged particle beam. Thus, the beam controller can control the charged particle beam by the electric field. For example, the beam controller deflects the charged particle beam by generating an electric field consisting essentially of a dipole component in the path. Further, the beam controller can correct aberrations of the charged particle beam by generating an electric field consisting of a multipole component in the path. Alternatively, the beam controller can converge the charged particle beam as an electrostatic lens.

The electrodes of each beam controller are formed on an insulator extending along the path of the charged particle beam, and a plurality of beam controllers are provided on the insulator. Consequently, a single charged particle beam control apparatus has a plurality of beam controllers. Accordingly, a single charged particle beam control apparatus can perform consecutive and multiple beam control operations, i.e. deflection of the charged particle beam and aberration correction, in such a manner that the charged particle beam is deflected a plurality of times, or aberrations are corrected after the charged particle beam has been deflected. Moreover, the overall length of the system can be shortened in comparison to a case where only one beam controller can be provided on one charged particle beam control apparatus. Thus, a plurality of beam controllers for controlling the charged particle beam can be inserted all together in a narrow space at the upstream side of a lens as viewed in the travel direction of the charged particle beam to correct aberrations due to the lens.

Further, because the electrodes are formed on an insulator, the positional accuracy of the electrodes is determined by the processing accuracy of the insulator. Thus, the electrodes can be positioned more accurately than in a case where each individual electrode is supported by an insulator, and the electrodes are combined together after being aligned with respect to each other. Accordingly, it is possible to minimize the generation of aberrations by the charged particle beam control apparatus itself due to a non-uniform electric field component during beam control.

Further, once the insulator has been processed, each electrode can be formed simply by coating an electrically conductive substance on the surface of the insulator. Therefore, it is unnecessary to shape each of the plurality of electrodes and hence easy to form the electrodes. In addition, tolerances can be reduced. Thus, it is possible to minimize aberrations during beam control.

The beam controller (11, 12) may have at least two pairs of electrodes (11a, 11c, 11b, 11d, 12a, 12c, 12b, 12d) facing each other across the path.

In addition, the charged particle beam control apparatus (A) according to the present invention may have a deflecting electric field generator (V11a-V11d, V12a-V12d, 16) for applying a voltage to each of the electrodes (11a-11d, 12a-12d) of the at least two beam controllers (11, 12) provided along the path, thereby causing the beam controllers (11, 12) to generate an electric field for deflecting the charged particle beam.

In addition, a grounded part (14) may be provided between two adjacent electrodes (11a-11d, 12a-12d) arranged along the path.

The grounded part (14) may be formed from an electrically conductive substance coated on a part of the surface of the insulator (13).

In addition, the present invention provides a charged particle beam optical apparatus having a lens (L2, L3) for focusing a charged particle beam. In the charged particle beam optical apparatus, the charged particle beam control apparatus (A) may be disposed at a position that is on the upstream side of the lens (L2, L3) as viewed in the direction of travel of the charged particle beam and that faces the lens (L2, L3).

In addition, the present invention provides a charged particle beam defect inspection apparatus. The charged particle beam defect inspection apparatus has a primary optical system (10) for applying a charged particle beam from a charged particle source (S) onto an object (M) as a primary beam (B1). The charged particle beam defect inspection apparatus further has a secondary optical system (20) for focusing electrons obtained from the object (M) as a result of application of the primary beam (B1) onto a detection surface (31) as a secondary beam (B2). The primary optical system (10) and the secondary optical system (20) have a plurality of lenses for focusing the charged particle beam. The charged particle beam control apparatus (A) may be disposed at a position that is on the upstream side of each of the lenses as viewed in the travel direction of the charged particle beam and that faces the lens.

In addition, the present invention provides a charged particle beam control method wherein a charged particle beam is focused through a lens (L2, L3). In the charged particle beam control method, the charged particle beam control apparatus (A) may be disposed at a position that is on the upstream side of the lens (L2, L3) as viewed in the travel direction of the charged particle beam and that faces the lens (L2, L3). By using the beam controllers (11, 12) provided along the path, the charged particle beam is deflected for each beam controller (11, 12) to control the charged particle beam in advance so that the path of the charged particle beam will be coincident with the optical axis of the lens (L2, L3). Then, the charged particle beam is allowed to enter the lens (L2, L3).

In addition, the present invention provides a charged particle beam control method wherein a charged particle beam is focused through a lens. In the charged particle beam control method, the charged particle beam control apparatus (A) may be disposed in the path of the charged particle beam. Aberrations due to decentration of the lens are corrected by applying a voltage to each of the plurality of electrodes (11a-11d, 12a-12d) provided around the path.

It is also possible to control the charged particle beam so as to correct aberrations due to decentration of the lens by applying a voltage to the plurality of electrodes (11a-11d, 12a-12d) provided around the path.

### BRIEF DESCRIPTION OF THE DRAWINGS

FIG. 1 is a vertical sectional view showing the arrangement of a charged particle beam control apparatus according to an embodiment of the present invention.

FIG. 2 is a sectional view of the charged particle beam control apparatus, taken along the line I-I in FIG. 1.

FIG. 3 is a sectional view of the charged particle beam control apparatus, taken along the line II-II in FIG. 1.

FIG. 4 is a sectional view of the charged particle beam control apparatus, taken along the line III-III in FIG. 1.

FIG. 5 is a diagram for describing a method of correcting the path of a charged particle beam in which a charged particle beam control apparatus according to the present invention is used.

FIG. 6 is a vertical sectional view showing the arrangement of a charged particle beam control apparatus according to another embodiment of the present invention.

FIG. 7 is a diagram showing the arrangement of a charged particle beam defect inspection apparatus according to an embodiment of the present invention.

FIG. 8 is a diagram showing the path of a primary beam in the charged particle beam defect inspection apparatus according to the embodiment of the present invention.

FIGS. 9(a) and 9(b) are diagrams for describing the operating principle of a Wien filter.

FIG. 10 is a diagram showing the path of a secondary beam in the charged particle beam defect inspection apparatus according to the embodiment of the present invention.

FIG. 11 is a diagram for describing an ideal method of correcting the path of a charged particle beam.

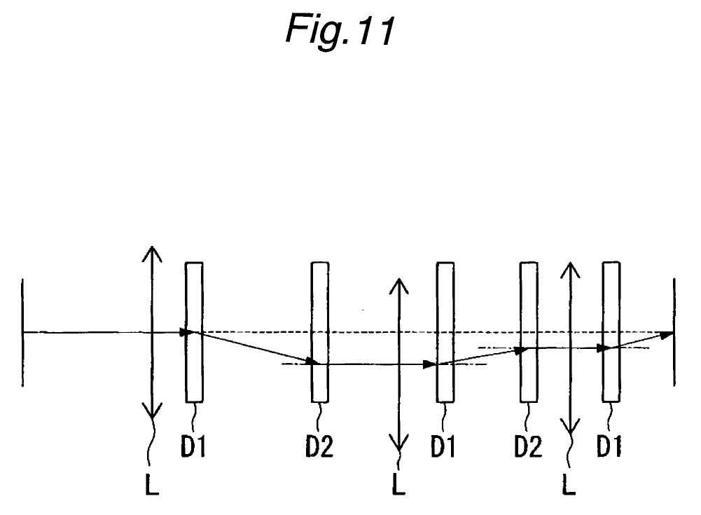

FIG. 12 is a diagram for describing a method of correcting the path of a charged particle beam according to the related art.

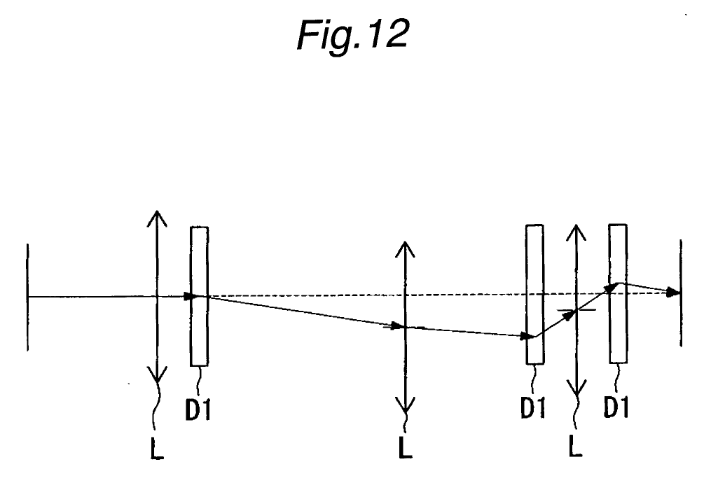

### DETAILED DESCRIPTION OF THE INVENTION

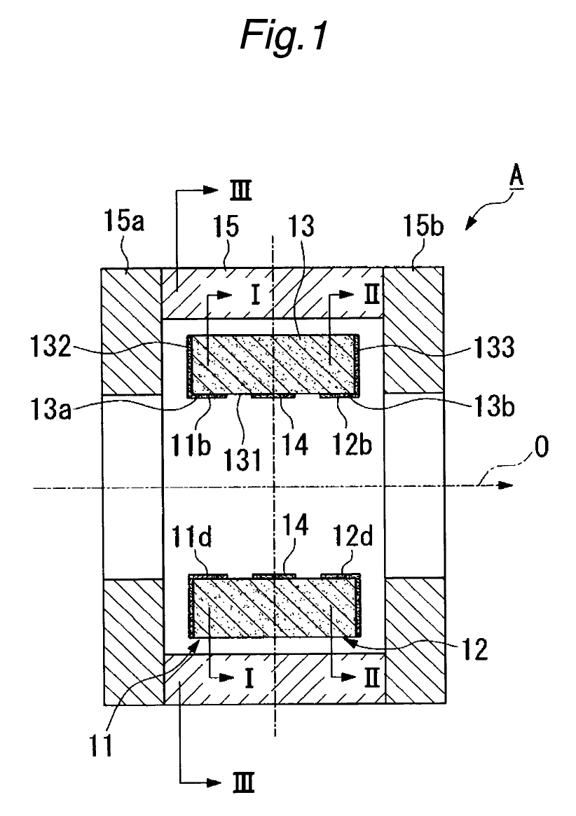

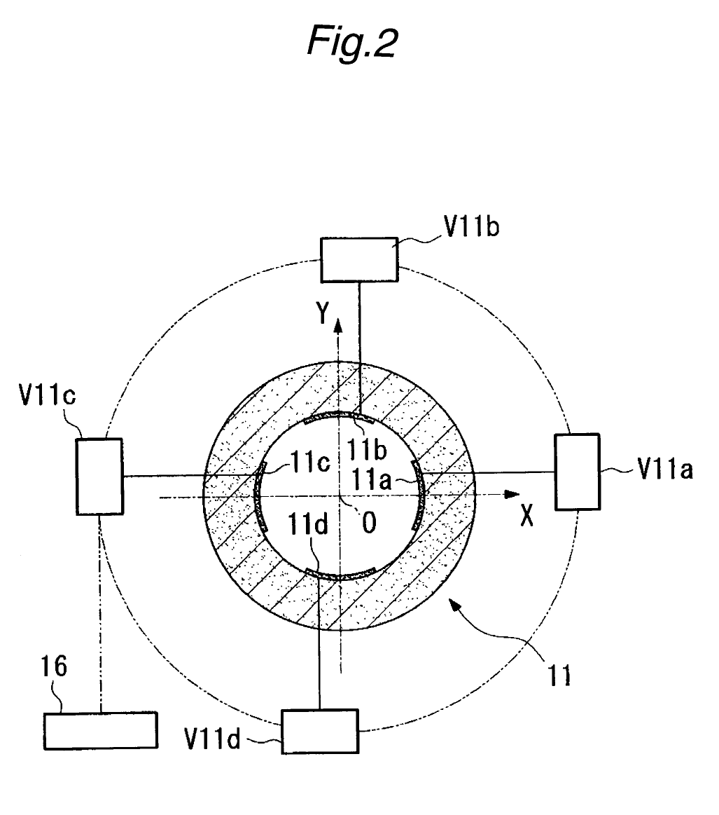

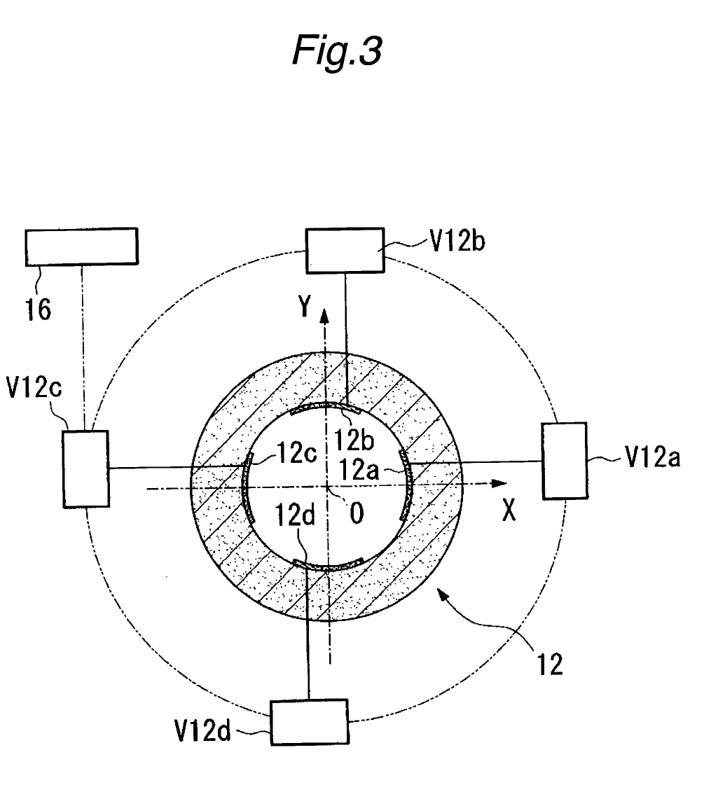

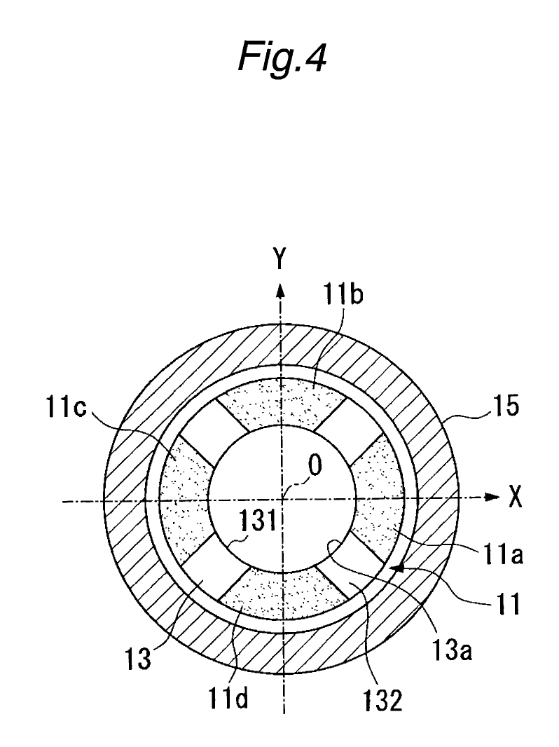

A charged particle beam control apparatus according to an embodiment of the present invention, together with a charged particle beam optical apparatus and charged particle beam defect inspection apparatus using the same, will be described below in detail with reference to the accompanying drawings. FIGS. 1 to 4 are diagrams showing the arrangement of a charged particle beam control apparatus according to an embodiment of the present invention. FIG. 1 is a vertical sectional view of the charged particle beam control apparatus. FIG. 2 is a sectional view of the charged particle beam control apparatus, taken along the line I-I in FIG. 1. FIG. 3 is a sectional view of the charged particle beam control apparatus, taken along the line II-II in FIG. 1. FIG. 4 is a sectional view taken along the line III-III in FIG. 1.

In the figures, the charged particle beam control apparatus A has beam controllers 11 and 12 for generating an electric field in the path of a charged particle beam. As shown in FIG. 2, the beam controller 11 has four electrodes 11a, 11b, 11c and lid equally spaced every 90° on a circumference centered at a center axis O. Among the four, the electrodes 11a and 11c face each other across the center axis O (in the X axis direction in FIG. 2), and the electrodes 11b and 11d face each other across the center axis O (in the Y axis direction in FIG. 2). As shown in FIG. 3, the beam controller 12 has four electrodes 12a, 12b, 12c and 12d equally spaced every 90° on a circumference centered at the center axis O. Among the four, the electrodes 12a and 12c face each other across the center axis O (in the X axis direction in FIG. 3), and the electrodes 12b and 12d face each other across the center axis O (in the Y axis direction in FIG. 3). The beam controllers 11 and 12 are arranged in series along the center axis O.

The electrodes 11a-11d and 12a-12d of the beam controllers 11 and 12 are each coated on a part of the surface of a cylindrical insulator 13 formed from a ceramic material or the like. The electrodes 11a-11d and the electrodes 12a-12d are each made of an electrically conductive substance. Au (gold), for example, is usable as the electrically conductive substance. As shown in FIGS. 1 and 4, the electrodes 11a-11d are formed to extend from a position on the inner peripheral surface 131 of the insulator 13 that faces one opening 13a thereof to one end surface 132 of the insulator 13. The electrodes 12a-12d are formed to extend from a position on the inner peripheral surface 131 of the insulator 13 that faces the other opening 13b thereof to the other end surface 133 of the insulator 13. The electrodes 11a-11d and 12a-12d are formed so that each pair of electrodes 11a-12a, 11b-12b, 11c-12c and 11d-12d are superimposed on one another as seen from the direction of the center axis O, i.e. each pair of electrodes are aligned with each other along the center axis O.

In addition, a grounded part 14 is provided between the beam controllers 11 and 12 at an intermediate position between the electrodes 11a-11d and 12a-12d. The grounded part 14 is formed by coating Au as an electrically conductive substance on the inner peripheral surface 131 of the insulator 13.

A cover 15 is provided outside the insulator 13. The cover 15 is formed from a substance having electrical conductivity, e.g. a metal. The cover 15 is grounded. The cover 15 has annular end plates 15a and 15b at both ends thereof. The end plates 15a and 15b each have an opening of the same diameter as the inner diameter of the insulator 13. The end plates 15a and 15b are provided so that sides of the end plates 15a and 15b that face the insulator 13 are separate from the insulator 13 and face the electrodes 11a-11d and 12a-12d, respectively.

Further, as shown in FIGS. 2 and 3, the charged particle beam control apparatus A has power sources V11a-V11d for applying voltages to the electrodes 11a-11d and power sources V12a-V12d for applying voltages to the electrodes 12a-12d. The power sources V11a-V11d and V12a-V12d are controlled by an electrode power source control system 16. Voltages applied to the electrodes 11a-11d and 12a-12d are adjustable independently of each other under the control of the electrode power source control system 16.

To deflect the charged particle beam by the beam controllers 11 and 12, for example, the electrode power source control system 16, the power sources V11a-V11d and the power sources V12a-V12d constitute a deflecting electric field generator. At this time, the deflecting electric field generator controls the beam controllers 11 and 12 to generate an electric field consisting essentially of a dipole component in an area containing the center axis O where the charged particle beam passes.

When either or both of the beam controllers 11 and 12 are used as stigmators, the electrode power source control system 16 and the power sources V11a-V11d or the power sources V12a-V12d constitute an aberration correcting electric field generator. At this time, the aberration correcting electric field generator controls the beam controllers 11 and 12 to generate a multipole electric field consisting essentially of a quadrupole component in an area containing the center axis O where the charged particle beam passes.

Thus, the electrode power source control system 16, the power sources V11a-V11d and the power sources V12a-V12d apply voltages to the electrodes 11a-11d and to the electrodes 12a-12d under control. At this time, the beam controllers 11 and 12 operate as deflectors, stigmators, or electrostatic lenses, whereby the charged particle beam is controlled.

In the charged particle beam control apparatus A arranged as stated above, the electrodes 11a-11d and 12a-12d of the beam controllers 11 and 12 are formed on the insulator 13 extending along the path of the charged particle beam. Consequently, a single charged particle beam control apparatus A has two beam controllers 11 and 12. Accordingly, a single charged particle beam control apparatus A can perform two consecutive beam control operations, i.e. deflection of the charged particle beam and aberration correction, in such a manner that the charged particle beam is deflected twice consecutively, or aberrations are corrected immediately after the charged particle beam has been deflected. Moreover, the overall length of the system can be shortened in comparison to a case where only one beam controller can be provided on one charged particle beam control apparatus.

Further, because the electrodes 11a-11d and 12a-12d are formed on the insulator 13, the positional accuracy of the electrodes 11a-11d and 12a-12d is determined by the processing accuracy of the insulator 13. Thus, the electrodes 11a-11d and 12a-12d can be positioned accurately. Accordingly, it is possible to minimize the generation of aberrations by the charged particle beam control apparatus A itself due to a non-uniform electric field component during beam control.

Further, once the insulator 13 has been processed, each of the electrodes 11a-11d and 12a-12d can be formed simply by coating an electrically conductive substance on the surface of the insulator 13. Therefore, it is unnecessary to shape each electrode and hence easy to form the electrodes 11a-11d and 12a-12d. In addition, tolerances can be reduced. Thus, it is possible to minimize aberrations during beam control.

Further, the charged particle beam control apparatus A has two pairs of mutually opposing electrodes 11a-11c and 11b-11d and two pairs of electrodes 12a-12c and 12b-12d provided in the beam controllers 11 and 12, respectively, in such a manner that the two pairs of mutually opposing electrodes in each of the beam controllers 11 and 12 face each other across the center axis O in two independent directions. Therefore, when the beam controllers 11 and 12 are used as deflectors, an electric field consisting essentially of a dipole component is generated between each pair of mutually opposing electrodes, whereby an electric field in which the electric fields in two directions are superimposed on one another is generated in the path of the charged particle beam. Thus, the charged particle beam can be deflected in any desired direction. In this embodiment, the pairs of mutually opposing electrodes 11a-11c, 11b-11d, 12a-12c and 12b-12d are arranged so that the X axis direction and the Y axis direction, in which each pair of mutually opposing electrodes face each other, perpendicularly intersect each other. Accordingly, it is easy to control the direction of deflection.

Furthermore, the beam controllers 11 and 12 are provided in series along the path of the charged particle beam. If the beam controllers 11 and 12 are used as two deflectors, the position and tilt of the charged particle beam can be controlled as desired.

It should be noted that there is almost no difference in the amount of aberration between an arrangement in which the two beam controllers 11 and 12 are provided in a single charged particle beam control apparatus A and an arrangement in which two deflectors are disposed separately from each other.

For example, the charged particle beam control apparatus A may be arranged as follows:

(1) The length of the insulator 13 in the direction of the center axis O is 5 mm. The inner diameter of the insulator 13 is 20 mm, and the outer diameter of the insulator 13 is 30 mm.

(2) The lengths in the direction of the center axis O of the electrodes 11a-11d and 12a-12d and the grounded part 14, which are formed on the inner peripheral surface 131 of the insulator 13, are each 1 mm, and the distance between the electrodes 11a-11d and the grounded part 14 and the distance between the grounded part 14 and the electrodes 12a-12d are each 1 mm.

(3) The angle a that the space between each pair of adjacent electrodes subtends at the center axis O is 3°.

(4) The thickness of each of the end plates 15a and 15b is 2 mm, and the end plates 15a and 15b are disposed 1 mm apart from the electrodes 11a-11d and the electrodes 12a-12d, respectively.

(5) The overall length of the cover 15 in the direction of the center axis O is 11 mm, and the outer diameter of the cover 15 is 38 mm.

In this case, voltages may be applied to the electrodes 11a-11d and 12a-12d as follows.

(6) A voltage of +100 V is applied to the electrode 11a; −100 V to the electrode 11c; 0 V to the electrodes 11b and 11d; −100 V to the electrode 12a; +100V to the electrode 12c; and 0 V to the electrodes 12b and 12d.

Under the above-described conditions, an electron beam traveling in the direction of the center axis O with an energy of 4 keV can be moved parallel to itself through 12 μm in the positive direction of the X axis (rightwardly in FIGS. 2 and 3).

Similarly, the electron beam can be moved in the Y axis direction by generating an electric field in the Y axis direction. By combining together the movements in the X and Y axis directions, the electron beam can be moved in a desired direction. Distortion aberration in this system is 0.00351%. It should be noted that the distortion of a deflector having the same size as that of one of the beam controllers 11 and 12 is about 0.0410%.

When the beam controllers 11 and 12 are used as stigmators, a positive voltage should be applied to either one of the pairs of mutually opposing electrodes 11a-11c and 11b-11d and to either one of the pairs of mutually opposing electrodes 12a-12c and 12b-12d, and a negative voltage to the other pairs.

Thus, the charged particle beam control apparatus A according to this embodiment allows an electric field consisting of a multipole component (up to a quadrupole component) to be generated in the path of the charged particle beam as desired with the electrodes 11a-11d and the electrodes 12a-12d. Further, the beam controllers 11 and 12 can be used as deflectors for two axis directions or as stigmators. The charged particle beam can be controlled as desired by a combination of the beam controllers 11 and 12, which are usable as deflectors for two axis directions or as stigmators.

It should be noted that because the electrodes 11a-11d and the electrodes 12a-12d are formed to extend from the inner peripheral surface 131 of the insulator 13 to the end surfaces 132 and 133 thereof, the electrode area is increased, and hence the angle of deflection of the charged particle beam obtainable with a predetermined voltage increases. Accordingly, the control of the charged particle beam is facilitated.

The grounded part 14 provided between the electrodes 11a-11d and the electrodes 12a-12d sets the electric potential at an intermediate position between the electrodes 11a-11d and 12a-12d at 0 V to prevent the electric potential at this position from being made unstable by voltages applied to the electrodes 11a-11d and 12a-12d. The grounded part 14 cuts off the electric field generated by the beam controller 11 and the electric field generated by the beam controller 12, thus ensuring independence for each of the beam controllers 11 and 12. With this arrangement, the electric fields of the beam controllers 11 and 12 can be effectively kept independent of each other when the beam controllers 11 and 12 are used as stigmators, in particular.

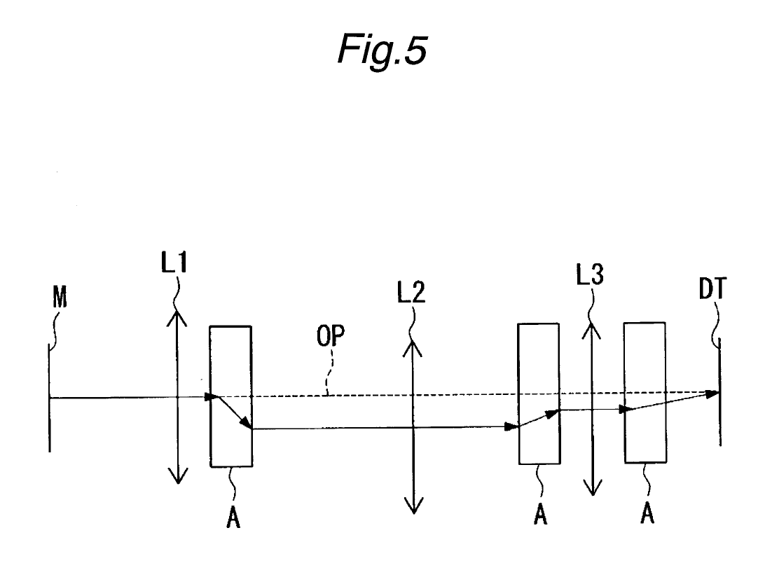

FIG. 5 is a diagram showing an example of a charged particle beam optical apparatus having a plurality of lenses for focusing a charged particle beam. In the figure, reference symbol M denotes an object emitting electrons as charged particles. DT denotes a detection surface on which the charged particle beam is imaged. L1, L2 and L3 denote lenses for focusing the charged particle beam, e.g. electrostatic lenses. OP denotes an ideal optical axis of the whole apparatus. In the illustrated arrangement, the optical axes of the lenses L2 and L3 are displaced from the ideal optical axis OP. A charged particle beam control apparatus A such as that shown in FIGS. 1 to 4 is inserted at the upstream side (left-hand side in FIG. 5) of each of the lenses L2 and L3 as viewed in the charged particle beam travel direction.

In the charged particle beam control apparatus A according to this embodiment, two beam controllers 11 and 12 are provided on a single insulator 13, as shown in FIGS. 1 to 4, to shorten the overall length thereof. Therefore, the charged particle beam control apparatus A can be disposed in a narrow space between lenses. According to a charged particle beam control method of this embodiment, the beam controllers 11 and 12 are used as two deflectors, and as shown in FIG. 5, the charged particle beam is deflected for each beam controller to correct the position and tilt of the charged particle beam, thereby previously controlling the charged particle beam so that the path of the charged particle beam will be coincident with the optical axis of each of the lenses L2 and L3. Then, the charged particle beam is allowed to enter the lenses L2 and L3. By making the path of the charged particle beam coincident with the optical axis of each of the lenses L2 and L3 in this way, it is possible to suppress generation of extra aberration by the lenses L2 and L3.

To correct the position and tilt of the charged particle beam, for example, the electrode power source control system 16, the power sources V11a-V11d and the power sources V12a-V12d are combined together to form a deflecting electric field generator. With the deflecting electric field generator, the beam controller 11 is caused to generate an electric field whereby the charged particle beam is deflected so as to intersect the optical axis at the position of the beam controller 12. Further, the beam controller 12 is caused to generate an electric field whereby the charged particle beam is deflected so as to coincide with the optical axis.

In the charged particle beam optical apparatus shown in FIG. 5, another charged particle beam control apparatus A is disposed at a position that is on the downstream side of the lens L3 as viewed in the charged particle beam travel direction and that faces the detection surface DT. The charged particle beam control apparatus A disposed at this position only needs to deflect the charged particle beam to the detection center of the detection surface DT. Therefore, it need not correct the tilt of the charged particle beam. Accordingly, only either one of the beam controllers 11 and 12 needs to be used as a deflector, and the other of them can be used as a stigmator for correcting aberrations of the charged particle beam. That is, according to the charged particle beam control method of this embodiment, voltages are applied to the electrodes 11a-11d or to the electrodes 12a-12d to generate a multipole electric field consisting essentially of a quadrupole component in the area containing the center axis O where the charged particle beam passes, thereby correcting distortion aberration due to the lens. Alternatively, a uniform voltage is applied to the electrodes 11a-11d or to the electrodes 12a-12d to generate an electric field of an electrostatic lens in the area containing the center axis O where the charged particle beam passes, thereby correcting aberrations due to the lens.

As has been stated above, the charged particle beam control apparatus A according to this embodiment can be inserted into a narrow space between lenses constituting a charged particle beam optical apparatus to control the charged particle beam, whereby aberrations can be reduced.

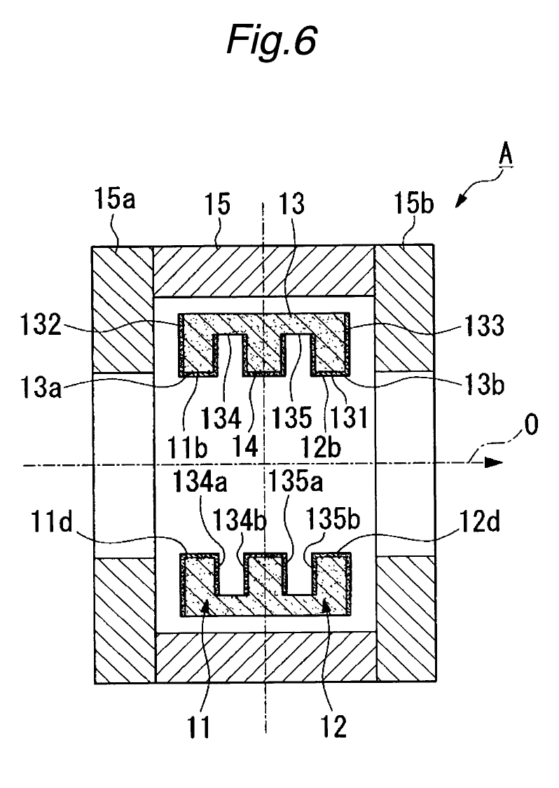

Although the cylindrical insulator 13 is used in the foregoing embodiment, the arrangement of the charged particle beam control apparatus A may be as shown in FIG. 6. That is, a groove 134 is provided between the electrodes 11a-11d and the grounded part 14. Similarly, a groove 135 is provided between the electrodes 12a-12d and the grounded part 14. The grooves 134 and 135 increase in diameter toward the outside from the inner peripheral surface 131. The electrodes 11a-11d and 12a-12d and the grounded part 14 are formed on the surfaces 134a, 134b, 135a and 135b of the grooves 134 and 135. Such an arrangement allows an increase in the deflection angle of the charged particle beam obtainable when a predetermined voltage is applied, and hence facilitates the control of the charged particle beam, although the insulator becomes somewhat difficult to process. In addition, aberrations are improved.

Regarding the number of electrodes, the present invention is not necessarily limited to a quadrupole arrangement such as that in this embodiment. In general, a plurality of electrodes may be used. As the number of electrodes is increased, it becomes easier to generate a uniform dipole electric field. It also becomes possible to generate higher-order multipole components. For this purpose, an octopole arrangement in which electrodes are symmetrically arranged around the center axis may be used, by way of example.

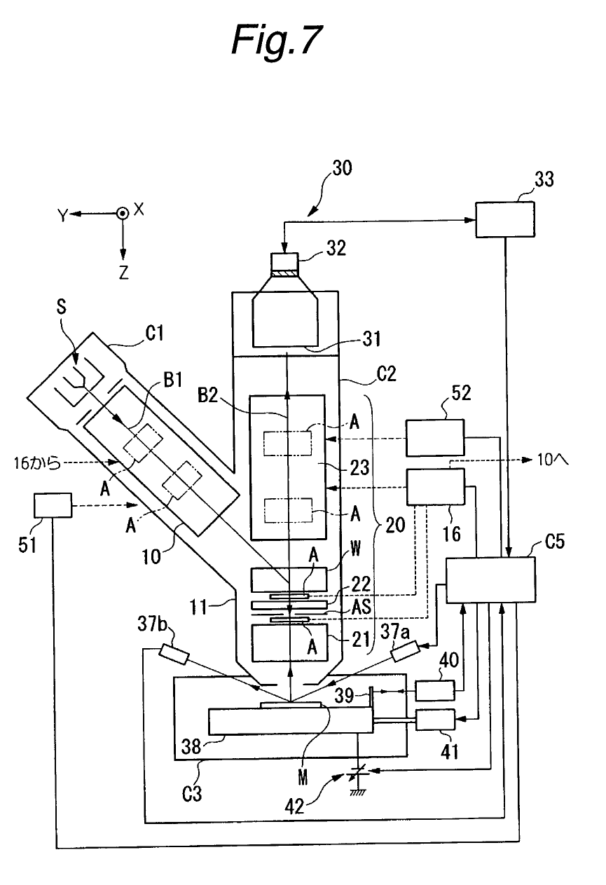

FIG. 7 is a diagram showing the arrangement of a charged particle beam defect inspection apparatus according to an embodiment of the present invention that has charged particle beam control apparatus A such as that shown in FIGS. 1 to 6. In the following description, an XYZ orthogonal coordinate system is set as shown in FIG. 7, and the positional relationship between constituent members will be described with reference to the XYZ orthogonal coordinate system. In the XYZ orthogonal coordinate system shown in FIG. 7, an XY plane is set in the object plane of a sample, and the direction normal to the object plane of the sample is set in the Z axis direction. The XYZ orthogonal coordinate system shown in FIG. 7 is actually such that the XY plane is set in a plane parallel to the horizontal plane, and the Z axis is set in the vertically downward direction.

The charged particle beam defect inspection apparatus according to this embodiment mainly comprises a primary column C1 for leading an electron beam (charged particle beam) to a sample M (object) as a primary beam B1, a secondary column C2 for focusing secondary electrons, which are obtained when the electron beam is applied to the sample M, onto a detection surface 31 of a detector 30 as a secondary beam B2, and a chamber C3 for accommodating the sample M as an object of observation. The optical axis of the primary column C1 is set in a direction oblique to the Z axis. The optical axis of the secondary column C2 is set approximately parallel to the Z axis. Accordingly, the primary beam B1 from the primary column C1 enters the secondary column C2 obliquely. The primary column C1, the secondary column C2 and the chamber C3 are connected with a vacuum evacuation system (not shown) so as to be evacuated by a vacuum pump, e.g. a turbopump, provided in the vacuum evacuation system. Thus, the insides of the primary column C1, the secondary column C2 and the chamber C3 are maintained in a vacuum state.

The primary column C1 is provided therein with a thermoelectron emission type electron gun S as a charged particle source. A primary optical system 10 is disposed on the optical axis of an electron beam emitted from the electron gun S. The primary optical system 10 comprises a field stop, irradiation lenses, an aligner, an aperture, etc. The irradiation lenses are electron lenses, e.g. circular lenses, quadrupole lenses, or octopole lenses. The converging characteristics of these lenses with respect to the primary beam B1 change according to the value of the voltage applied thereto. It should be noted that the irradiation lenses may be rotationally symmetric lenses known as “unipotential lenses” or “Einzel lenses”. A charged particle beam control apparatus A such as that shown in FIGS. 1 to 6 is disposed at the upstream side of each irradiation lens as viewed in the charged particle beam travel direction.

A secondary optical system 20 is placed in the secondary column C2. The secondary optical system 20 leads secondary electrons emitted from the sample M when irradiated with the primary beam B1 as a secondary beam B2 and focuses it onto the detection surface 31 of the detector 30. The secondary optical system 20 has, in order from the sample M side in the −Z direction, a first pre-lens 21, an aperture stop AS, a second pre-lens 22, a Wien filter W, and a post-optical system 23 including a stigmator, image-forming lenses, an aligner, a field stop, etc. The first pre-lens 21, the second pre-lens 22 and the image-forming lenses in the secondary optical system 20 are electron lenses, e.g. circular lenses, quadrupole lenses, or octopole lenses. It should be noted that the first pre-lens 21, the second pre-lens 22 and the image-forming lenses may be rotationally symmetric lenses known as “unipotential lenses” or “Einzel lenses”. A charged particle beam control apparatus A such as that shown in FIGS. 1 to 6 is disposed at the upstream side of each of these lenses as viewed in the charged particle beam travel direction.

A main control system C5 controls the values of voltage and electric current supplied to each part of the primary and secondary optical systems 10 and 20. More specifically, the main control system C5 outputs control signals to a primary optical system control unit 51, a secondary optical system control unit 52 and the electrode power source control system 16 of the charged particle beam control apparatus A to control the optical characteristics of the primary and secondary optical systems 10 and 20 and to perform the control of the charged particle beam control apparatus A.

The detector 30 detects the secondary beam B2 imaged on the detection surface 31 through the secondary optical system 20. The detected electrons are amplified and then converted into a light signal through a fluorescent screen. The light signal enters a camera 32 equipped with a TDI sensor, for example. The camera 32 is connected with a control unit 33 that is controlled by the main control system C5 to read image signals from the camera 32 and to sequentially output them to the main control system C5. The main control system C5 performs image processing, e.g. template matching, on the image signals output from the control unit 33 to judge whether or not there is a defect on the sample M.

Further, an XY stage 38 is provided in the chamber C3. The XY stage 38 is movable in the XY plane with the sample M placed thereon. An L-shaped moving mirror 39 is secured to one end of the XY stage 38. A laser interferometer 40 is disposed at a position facing the mirror surface of the moving mirror 39. The laser interferometer 40 measures the X and Y coordinates of the XY stage 38 and the angle of rotation thereof in the XY plane by using the reflected laser beam from the moving mirror 39. The results of the measurement are output to the main control system C5. The main control system C5 outputs a control signal to a driver 41 on the basis of the measurement results to control the position of the XY stage 38 in the XY plane. The main control system C5 further outputs a control signal to a Z sensor comprising a light-sending system 37a and a light-receiving system 37b to measure the coordinate of the position of the sample M in the Z axis direction. It is preferable to provide, in addition to the XY stage 38, a Z stage (not shown) for changing the position of the sample M in the Z axis direction on the basis of the measurement of the position coordinate in the Z axis direction and a tilt stage (not shown) for controlling the tilt of the object plane of the sample M with respect to the XY plane.

Reference numeral 42 in the figure denotes a variable power source for setting a negative voltage for the sample M. The set voltage of the sample M is controlled by the main control system C5. The reason why a negative voltage is set for the sample M is to accelerate secondary electrons emitted from the sample M when irradiated with the primary beam B1 in the direction of the first pre-lens 21, i.e. in the −Z direction.

The charged particle beam defect inspection apparatus having the charged particle beam control apparatus A according to this embodiment is arranged as stated above. Next, let us detail the method for defect inspection of the sample M carried out by the charged particle beam defect inspection apparatus while describing the paths of the primary and secondary beams B1 and B2.

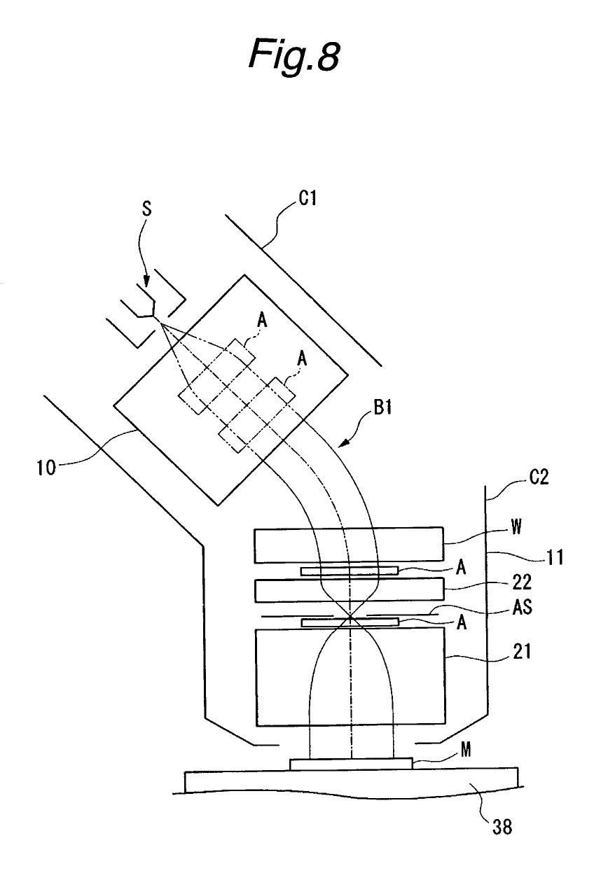

FIG. 8 is a diagram showing the path of the primary beam B1 in the charged particle beam defect inspection apparatus according to the embodiment of the present invention. In the figure, illustration of the members provided in the primary optical system 10 is omitted with a view to facilitating understanding. The primary beam B1 emitted from the electron gun S is converged or diverged (illustration of the envelope of the beam in the primary optical system 10 is omitted) under the influence of electric fields formed by the irradiation lenses in the primary optical system 10. Thus, the primary beam B1 is formed into a parallel beam and enters the Wien filter W from an oblique direction. At this time, the primary beam B1 is led while being made coincident with the optical axes of the irradiation lenses by the charged particle beam control apparatus A. As the primary beam B1 passes through the Wien filter W, the optical path thereof is deflected to a direction approximately parallel to the Z axis. The primary beam B1 deflected by the Wien filter W is focused by the second pre-lens 22 to reach the aperture stop AS where it forms an image of the electron gun S. The primary beam B1 passing through the aperture stop AS is subjected to the lens action of the first pre-lens 21 to illuminate the sample M with Koehler illumination.

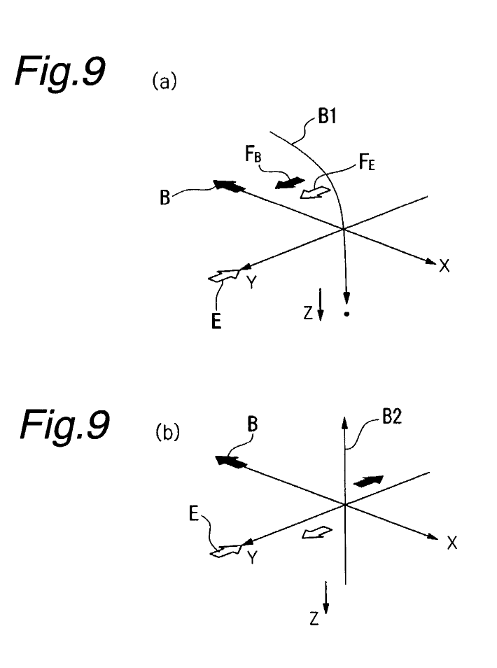

The Wien filter W is a beam separator that deflects charged particles or allows them to travel straight according to the travel direction of the charged particles. FIGS. 9(a) and 9(b) are diagrams for describing the operating principle of the Wien filter W. As shown in the figures, the primary beam B1 entering the Wien filter W from the primary optical system 10 is deflected by the Wien filter W. The reason for this is as follows. As shown in FIG. 9(a), when electrons with an electric charge q that form the primary beam B1 travel at a speed v in the +Z axis direction through a field where an electric field E and a magnetic field B perpendicularly intersect each other, the electrons are subjected to the resultant force from force F_{E} (=qE) due to the electric field and force F_{B} (=qvB) due to the magnetic field, which act in the +Y direction. On the other hand, the secondary beam B2 emitted from the sample M travels straight through the Wien filter W. The reason for this is as follows. As shown in FIG. 9(b), when electrons with an electric charge q that form the secondary beam B2 travel at a speed v in the −Z axis direction, the electrons are subjected to the resultant force from force F_{E} (=qE) due to the electric field that acts in the +Y direction and force F_{B} (=−qvB) due to the magnetic field that acts in the −Y direction. Thus, the resultant force F_{E}+F_{B} is zero.

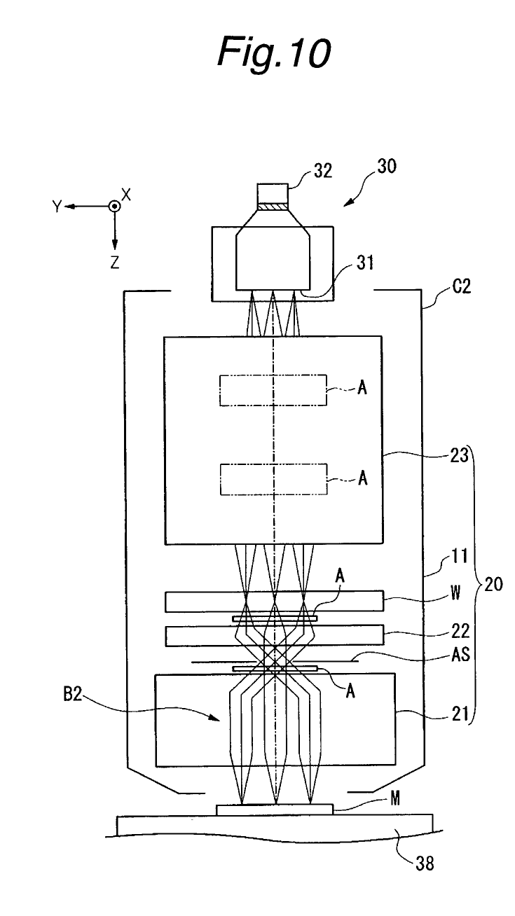

The process wherein secondary electrons obtained from the sample M when irradiated with the primary beam B1 are focused onto the detection surface 31 of the detector 30 as the secondary beam B2 will be described below. First, when the sample M is irradiated with the primary beam B1, secondary electrons are obtained from the sample M. The secondary electrons are distributed according to the surface configuration of the sample M, the material distribution thereof, the variation in the electric potential, and so forth. The secondary electrons are used as the secondary beam B2 to inspect the surface condition of the sample M. FIG. 10 is a diagram showing the path of the secondary beam B2 in the charged particle beam defect inspection apparatus according to the embodiment of the present invention. In the figure, illustration of some members provided in the secondary optical system 20 is omitted with a view to facilitating understanding. The energy of secondary electrons emitted from the sample M is low, i.e. of the order of 0.5 to 2 eV. The secondary electrons are focused as the secondary beam B2 while being accelerated through the first pre-lens 21. Subsequently, the secondary beam B2 passes through the aperture stop AS. The secondary beam B2 passing through the aperture stop AS is focused by the second pre-lens 22 so that an intermediate image formation plane is set in the center of the Wien filter W. A charged particle beam control apparatus A is disposed at the upstream side of the second pre-lens 22 as viewed in the travel direction of the secondary beam B2 to make the path of the secondary beam B2 coincident with the optical axis of the second pre-lens 22, and another charged particle beam control apparatus A is disposed at the upstream side of the Wien filter W to make the path of the secondary beam B2 coincident with the optical axis of the Wien filter W. The secondary beam B2 entering the Wien filter W from a direction opposite to the direction of incidence of the primary beam B1 is led by the Wien filter W in a direction different from the direction extending to the electron gun S. Thus, the secondary beam B2 is allowed to travel straight and imaged on the detection surface 31 of the detector 30 as an enlarged image of the object plane of the sample M by the post-optical system 23. In the post-optical system 23, another charged particle beam control apparatus A is disposed at the upstream side of each of the constituent lenses as viewed in the travel direction of the secondary beam B2 to make the path of the secondary beam B2 coincident with the optical axis of the associated lens and to correct aberrations due to the lens.

In the charged particle beam defect inspection apparatus arranged as stated above, the path of the primary beam B1 and the path of the secondary beam B2 are made coincident with the optical axes of the lenses by the associated charged particle beam control apparatus A. Accordingly, it is possible to minimize the occurrence of aberrations due to the lenses and hence possible to improve the quality of the image formed. The charged particle beam control apparatus A can also correct aberrations. Therefore, the quality of the image formed can be further improved.

In the charged particle beam control apparatus according to the embodiment of the present invention, electrodes of a beam controller for generating an electric field in the path of a charged particle beam are formed by coating an electrically conductive substance on a part of the surface of an insulator extending along the path. In addition, a plurality of such beam controllers are provided on the insulator along the path. Accordingly, the charged particle beam control apparatus can be inserted into a narrow space between lenses to correct the path of the charged particle beam and to correct aberrations.

The entire disclosure of Japanese Patent Application No. 2001-210862 filed on Jul. 11, 2001 including specification, claims, drawings and summary is incorporated herein by reference in its entirety.

What is claimed is:

1. A charged particle beam control apparatus comprising:
an insulator extending along a path of a charged particle beam; and
a beam controller for generating an electric field in the path of said charged particle beam;
said beam controller having a plurality of electrodes around said path to apply a voltage;
wherein said electrodes are provided on said insulator along said path, and each of said electrodes has an electrically conductive substance coated on a part of a surface of said insulator.

2. A charged particle beam control apparatus according to claim 1, wherein said beam controller has at least two pairs of electrodes facing each other across said path.

3. A charged particle beam control apparatus according to claim 1, comprising:
at least two beam controllers provided along said path; and
a deflecting electric field generator for applying a voltage to each electrode of said at least two beam controllers, thereby causing said at least two beam controllers to generate an electric field for deflecting said charged particle beam.

4. A charged particle beam control apparatus according to claim 1, wherein said plurality of electrodes include two electrodes arranged adjacently to each other along said path;
said charged particle beam control apparatus further comprising:
a grounded part provided between said two electrodes.

5. A charged particle beam control apparatus according to claim 4, wherein said grounded part has an electrically conductive substance coated on a part of the surface of said insulator.

6. A charged particle beam optical apparatus having a lens for focusing a charged particle beam, said charged particle beam optical apparatus comprising:
a charged particle beam control apparatus disposed at a position that is on an upstream side of said lens as viewed in a direction of travel of said charged particle beam and that faces said lens:
said charged particle beam control apparatus including:
an insulator extending along a path of said charged particle beam; and
a beam controller for generating an electric field in the path of said charged particle beam;
said beam controller having a plurality of electrodes around said path to apply a voltage;
wherein said electrodes are provided on said insulator along said path, and each of said electrodes has an electrically conductive substance coated on a part of a surface of said insulator.

7. A charged particle beam optical apparatus according to claim 6, wherein said beam controller has at least two pairs of electrodes facing each other across said path.

8. A charged particle beam optical apparatus according to claim 6, wherein said charged particle beam control apparatus includes:
at least two beam controllers provided along said path; and
a deflecting electric field generator for applying a voltage to each electrode of said at least two beam controllers, thereby causing said at least two beam controllers to generate an electric field for deflecting said charged particle beam.

9. A charged particle beam optical apparatus according to claim 6, wherein said plurality of electrodes include two electrodes arranged adjacently to each other along said path; and
wherein said charged particle beam control apparatus further includes a grounded part provided between said two electrodes.

10. A charged particle beam optical apparatus according to claim 9, wherein said grounded part has an electrically conductive substance coated on a part of the surface of said insulator.

11. A charged particle beam defect inspection apparatus comprising:
a primary optical system for applying a charged particle beam from a charged particle source onto an object as a primary beam;
a secondary optical system for focusing electrons obtained from said object as a result of application of said primary beam onto a detection surface as a secondary beam;
said primary optical system and said secondary optical system having a plurality of lenses for focusing said charged particle beam; and
a charged particle beam control apparatus disposed at a position that is on an upstream side of each of said lenses as viewed in a direction of travel of said charged particle beam and that faces the lens;
said charged particle beam control apparatus including:
an insulator extending along a path of said charged particle beam; and
a beam controller for generating an electric field in the path of said charged particle beam;
said beam controller having a plurality of electrodes around said path to apply a voltage;
wherein said electrodes are provided on said insulator along said path, and each of said electrodes has an electrically conductive substance coated on a part of a surface of said insulator.

12. A charged particle beam defect inspection apparatus according to claim 11, wherein said beam controller has at least two pairs of electrodes facing each other across said path.

13. A charged particle beam defect inspection apparatus according to claim 11, wherein said charged particle beam control apparatus includes:
at least two beam controllers provided along said path; and
a deflecting electric field generator for applying a voltage to each electrode of said at least two beam controllers, thereby causing said at least two beam controllers to generate an electric field for deflecting said charged particle beam.

14. A charged particle beam defect inspection apparatus according to claim 11, wherein said plurality of electrodes include two electrodes arranged adjacently to each other along said path; and
wherein said charged particle beam control apparatus further includes a grounded part provided between said two electrodes.

15. A charged particle beam defect inspection apparatus according to claim 14, wherein said grounded part has an electrically conductive substance coated on a part of the surface of said insulator.

16. A charged particle beam control method wherein a charged particle beam is focused through a lens, said control method comprising the step of:
disposing a charged particle beam control apparatus at a position that is on an upstream side of said lens as viewed in a direction of travel of said charged particle beam and that faces said lens;
said charged particle beam control apparatus including:
an insulator extending along a path of said charged particle beam; and
a beam controller for generating an electric field in the path of said charged particle beam;
said beam controller having a plurality of electrodes around said path to apply a voltage;
wherein said electrodes are provided on said insulator along said path, and each of said electrodes has an electrically conductive substance coated on a part of a surface of said insulator;
said control method further comprising the step of deflecting said charged particle beam by using said beam controller provided along said path, whereby said charged particle beam is controlled in advance so that the path of said charged particle beam is coincident with an optical axis of said lens, and then said charged particle beam is allowed to enter said lens.

17. A charged particle beam control method according to claim 16, wherein said charged particle beam control apparatus includes:
at least two beam controllers provided along said path; and
a deflecting electric field generator for applying a voltage to each electrode of said at least two beam controllers, thereby causing said at least two beam controllers to generate an electric field for deflecting said charged particle beam.

18. A charged particle beam control method according to claim 16, wherein said plurality of electrodes include two electrodes arranged adjacently to each other along said path; and
wherein said charged particle beam control apparatus further includes a grounded part provided between said two electrodes.

19. A charged particle beam control method according to claim 18, wherein said grounded part has an electrically conductive substance coated on a part of the surface of said insulator.

20. A charged particle beam control method wherein a charged particle beam is focused through a lens, said control method comprising the step of:
disposing a charged particle beam control apparatus in a path of said charged particle beam;
said charged particle beam control apparatus including:
an insulator extending along the path of said charged particle beam; and
a beam controller for generating an electric field in the path of said charged particle beam;
said beam controller having a plurality of electrodes around said path to apply a voltage;
wherein said electrodes are provided on said insulator along said path, and each of said electrodes has an electrically conductive substance coated on a part of a surface of said insulator;
said control method further comprising the step of applying a voltage to said electrodes provided around said path to correct aberrations due to decentration of said lens.

21. A charged particle beam control method according to claim 20, wherein said beam controller has at least two pairs of electrodes facing each other across said path.

22. A charged particle beam control method according to claim 20, wherein said charged particle beam control apparatus includes:
at least two beam controllers provided along said path; and
a deflecting electric field generator for applying a voltage to each electrode of said at least two beam controllers, thereby causing said at least two beam controllers to generate an electric field for deflecting said charged particle beam.

23. A charged particle beam control method according to claim 20, wherein said plurality of electrodes include two electrodes arranged adjacently to each other along said path; and
wherein said charged particle beam control apparatus further includes a grounded part provided between said two electrodes.

24. A charged particle beam control method according to claim 23, wherein said grounded part has an electrically conductive substance coated on a part of the surface of said insulator.
